(19) United States
(12) Patent Application Publication
(10) Pub. No.: US 2026/0092819 A1
(43) Pub. Date: Apr. 2, 2026

(54) NON-CONTACT THERMOMETER

(71) Applicant: OMRON HEALTHCARE Co., Ltd., Muko-shi (JP)

(72) Inventors: Yoshikazu INAMI, Kyoto (JP); Minoru FUJINO, Kyoto (JP); Taiga SATO, Kyoto (JP); Takaaki OKANISHI, Kyoto (JP)

(21) Appl. No.: 19/413,057

(22) Filed: Dec. 9, 2025

Related U.S. Application Data
(63) Continuation of application No. PCT/JP2024/005728, filed on Feb. 19, 2024.

(30) Foreign Application Priority Data
Aug. 10, 2023 (JP) 2023-131258

(51) Int. Cl. G01K 13/20

(52) U.S. Cl. CPC G01K 13/223

(57) ABSTRACT

A hand-held type non-contact thermometer for which a measurement site is a forehead, the non-contact thermometer including: a casing having a rod shape including a fore end portion with a built-in infrared sensor; and a measurement button provided in the casing for operating the infrared sensor. The fore end portion of the casing includes a foremost end portion and a flat sensor surface extending to be inclined from the foremost end portion toward the base end portion. The measurement button is provided on the same side of the casing as the sensor surface in a side view.

### CROSS-REFERENCE TO RELATED APPLICATIONS

This is a continuation application of International Application No. PCT/JP2024/005728, with an international filing date of Feb. 19, 2024, which claims priority of Japanese Patent Application No. 2023-131258 filed on Aug. 10, 2023, the content of which is incorporated herein by reference.

### BACKGROUND

### 1. Technical Field

The present invention relates to a non-contact thermometer.

### 2. Description of Related Art

A non-contact thermometer has been known that detects infrared rays emitted from a human body to measure temperature (JP-S-1744710). In particular, in response to the recent pandemic of infectious diseases and the like, hand-held type or stationary non-contact thermometers in medical institutions, various facilities, and the like have become widespread.

In homes and small-scale facilities, there is also a demand for temperature measurement of not only another person but also oneself with a non-contact thermometer. In addition, in particular, in the case of home use, since a hand-held type that is smaller than a stationary type is advantageous, there is a high demand for a hand-held type non-contact thermometer.

### SUMMARY

In the non-contact thermometer, the temperature is measured by capturing the infrared ray radiated from the measurement site according to the temperature with the sensor. Therefore, in order to accurately measure the temperature, it is important that the positional relationship between the infrared sensor and the measurement site, the angle (the direction of the infrared sensor coincides with a perpendicular line passing through the center of the measurement site), the distance between the infrared sensor and the measurement site (perpendicular direction) are appropriately adjusted, and the positional relationship can be maintained during measurement. Note that some stationary non-contact thermometers include a camera and a display unit, and display in the display unit a guide of the position and size of the face superimposed on a real-time moving image captured by the camera so that the subject can hold one's face at an appropriate position and distance.

When temperature measurement is performed with a hand-held type non-contact thermometer with the forehead as a measurement site, it is also important not to give a sense of discomfort to the subject.

JP-S-1744710 discloses a hand-held type non-contact thermometer. This non-contact thermometer is a so-called pistol-shaped non-contact thermometer, and includes a grip portion and a cylindrical portion extending from a fore end of the grip portion in a direction different from the grip portion, that is, a connection portion between the grip portion and the cylindrical portion is bent. A sensor surface is provided at a fore end of the cylindrical portion. The angle of the sensor surface is not perpendicular to the extending direction of the cylindrical portion, and has an inclination corresponding to the inclination of the forehead. In addition, a measurement button is provided at a connection portion between the grip portion and the cylindrical portion. In the case of temperature measurement of another person with this pistol-shaped non-contact thermometer, the measurer visually observes and points the cylindrical portion at the subject substantially horizontally, so that the sensor surface can be easily caused to directly face the forehead of the subject. That is, the measurer can easily adjust the positional relationship between the infrared sensor and the measurement site and adjust the distance between the infrared sensor and the measurement site by particularly visually observing the cylindrical portion in the pistol-shaped non-contact thermometer. At the same time, the angle of the infrared sensor with respect to the forehead, which is the measurement surface, is adjusted by the angle of the sensor surface having the inclination corresponding to the inclination of the forehead. As described above, it is advantageous that the cylindrical portion has a certain length in order to adjust the positional relationship, the distance, and the angle by visually observing the cylindrical portion in the temperature measurement of another person. However, it is difficult to measure one's own forehead as a measurement site with a so-called pistol-shaped non-contact thermometer. Specifically, in the case of the pistol-shaped non-contact thermometer, it is difficult to adjust the distance and the angle by directly visually observing the sensor surface because the forehead of the self as the measurement site is close to the eyes and above the eyes. In addition, when the cylindrical portion is long, it is necessary to extend the arm holding the non-contact thermometer forward and raise the arm upward, and it is burdensome for the measurer to keep such postures of the arm, the elbow, and the wrist during measurement, depending on the measurer's physique or the like.

In addition, in the case of temperature measurement of another person with the pistol-shaped non-contact thermometer disclosed in JP-S-1744710, a subject, whose face is pointed with the cylindrical portion by a measurer who grips a grip portion with a finger placed on a measurement button provided at a connection portion, may feel a sense of unpleasantness or a sense of discomfort as if the muzzle of a pistol is pointed at the subject. The same applies to the case of temperature measurement of oneself, that is, the case of gripping the grip portion and pointing the cylindrical portion at one's own face.

An object of the present invention is to provide a hand-held type non-contact thermometer that: facilitates adjustment of a sensor surface of the non-contact thermometer to the appropriate positional relationship, angle, and distance with respect to the forehead, which is a measurement site, not only in a case where the temperature of another person but also of the user oneself is measured; does not require an arm, an elbow, and a wrist to be in an unreasonable posture in adjusting and maintaining the sensor surface to the appropriate positional relationship, angle, and distance; and can reduce a sense of discomfort at the time of temperature measurement.

An aspect of the present invention provides a hand-held type non-contact thermometer for which a measurement site is the forehead, the non-contact thermometer including: a casing having a rod shape extending along an axis and including a fore end portion with a built-in infrared sensor and a base end portion on an opposite side of the fore end portion, the axis being a line connecting centroids of a plurality of cross sections orthogonal to a longitudinal direction of the casing and being a straight line; and a measurement button that is provided in the casing and operates a measurement function of the non-contact thermometer, in which the fore end portion of the casing includes a foremost end portion and a flat sensor surface extending from the foremost end portion toward the base end portion so as to be inclined with respect to the axis, the infrared sensor is disposed in the casing so as to directly face the sensor surface, and the measurement button is provided on the same side of the casing as the sensor surface in a side view.

Here, in regard to the casing, a rod shape means that a line connecting centroids of a plurality of cross sections orthogonal to the longitudinal direction of the casing is an axis that is a straight line. The fact that the measurement button is provided on the same side of the casing as the sensor surface in a side view means that the measurement button is aligned with the most base end portion side of the sensor surface in the direction of the axis. The fact that the measurement button is aligned with the most base end portion side of the sensor surface in the direction of the axis is not limited to a case where the both are positioned on one straight line parallel to the axis, and includes a case where the positions of the both in the direction orthogonal to the axis are different.

At the time of temperature measurement, the sensor surface is pointed at the forehead which is the measurement site. The measurement button is provided on the same side of the casing as the sensor surface. Therefore, the sensor surface can be pointed at the forehead with a finger placed on the measurement button for both the temperature measurement of another person and the temperature measurement of oneself. Specifically, at the time of another person's temperature measurement, the measurer grips the casing such that the index finger touches the measurement button, so that the sensor surface provided on the same side as the measurement button faces the forehead of the subject. On the other hand, at the time of the temperature measurement of oneself, the measurer grips the casing such that the thumb is in contact with the measurement button, so that the sensor surface provided on the same side as the measurement button faces one's forehead. As described above, the non-contact thermometer of the present invention can measure the temperature of both another person and oneself.

The casing has a rod shape, the sensor surface has a flat shape extending obliquely with respect to the axis, and the measurement button is provided on the same side as the sensor surface in a side view. Therefore, at the time of measurement of another person, the measurer holds the casing such that the index finger is placed on the measurement button, and points the entire casing at the subject, so that it is easy to hold the sensor surface with the positional relationship, the angle, and the distance appropriately adjusted with respect to the forehead, which is the measurement site, without causing the arm, the elbow, and the wrist to take an unreasonable posture and without requiring the subject to change the direction and the posture of the face. In addition, at the time of measurement of oneself, by holding the casing so that the thumb is placed on the measurement button, and by matching the height position with the eyes by visually observing the thumb, it is easy to hold the sensor surface by appropriately adjusting the positional relationship, the angle, and the distance with respect to the forehead which is the measurement site without causing the arm, the elbow, and the wrist to take an unreasonable posture.

Since the casing has a rod shape, in both cases of: the temperature measurement of another person where a subject's forehead is pointed with the sensor surface and thus the fore end portion of the casing by the measurer; and the temperature measurement of oneself where the measurer's forehead is pointed with the fore end portion of the casing by oneself, a sense of unpleasantness or a sense of discomfort is reduced as compared with the case where a pistol-shaped object is pointed at the face.

The fore end portion of the casing does not have a pointed shape, since it is not formed only of the inclined surface, and includes the foremost end portion and a flat sensor surface extending obliquely from the foremost end portion. Therefore, in both cases of: the temperature measurement of another person where the subject's forehead is pointed with the fore end portion of the casing by the measurer; and the temperature measurement of oneself where the measurer's forehead is pointed with the fore end portion of the casing by oneself, a sense of unpleasantness or a sense of discomfort is reduced as compared with the case where the pointed end is pointed at the face.

An inclination angle of the sensor surface with respect to the axis is greater than 90 degrees and less than 180 degrees.

A recess may be provided in the casing, and the measurement button may be disposed in the recess.

The measurement button may have a concave shape.

A distance between the foremost end portion and a center of the measurement button in the direction of the axis may be 95 mm or less.

The casing may include a flat portion on an opposite side to the sensor surface in a side view.

A display unit may be provided on the flat portion.

An outline viewed from a direction of the axis of the casing may be in a convex curved surface shape except for the flat portion.

A hand-held type non-contact thermometer for which a measurement site is a forehead according to the present invention: facilitates adjustment of a sensor surface of the non-contact thermometer to the appropriate positional relationship, angle, and distance with respect to the forehead, which is a measurement site, not only in a case where the temperature of another person but also of the user oneself is measured; does not require an arm, an elbow, and a wrist to be in an unreasonable posture in adjusting and maintaining the sensor surface to the appropriate positional relationship, angle, and distance; and can reduce a sense of discomfort at the time of temperature measurement.

### BRIEF DESCRIPTION OF THE DRAWINGS

FIG. 1 is a perspective view of a non-contact thermometer according to an embodiment of the present invention as viewed from above.

FIG. 2 is a perspective view of the non-contact thermometer according to the embodiment of the present invention as viewed from below.

FIG. 3 is a plan view of the non-contact thermometer according to the embodiment of the present invention.

FIG. 4 is a bottom view of the non-contact thermometer according to the embodiment of the present invention.

FIG. 5 is a side view of the non-contact thermometer according to the embodiment of the present invention.

FIG. 6 is a front view of the non-contact thermometer according to the embodiment of the present invention

FIG. 7 is a front view of a sensor surface of the non-contact thermometer according to the embodiment of the present invention.

FIG. 8 is a rear view of the non-contact thermometer according to the embodiment of the present invention.

FIG. 9 is a partially enlarged cross-sectional view taken along line IX-IX in FIG. 3.

FIG. 10 is a block diagram of a non-contact thermometer according to the embodiment of the present invention.

FIG. 11 is a schematic view showing various use modes of the non-contact thermometer according to the embodiment of the present invention.

FIG. 12 is a schematic diagram illustrating the way of gripping, the positional relationship between the forehead and the sensor surface, and the distance (at the time of temperature measurement of another person) of the non-contact thermometer according to the embodiment of the present invention.

FIG. 13 is a schematic diagram illustrating the way of gripping, the positional relationship between the forehead and the sensor surface, and the distance (at the time of temperature measurement of oneself) of the non-contact thermometer according to the embodiment of the present invention.

FIG. 14 is a front view of a sensor surface of the non-contact thermometer according to a first modification of the embodiment of the present invention.

FIG. 15 is a front view of a sensor surface of the non-contact thermometer according to a second modification of the embodiment of the present invention.

### DETAILED DESCRIPTION

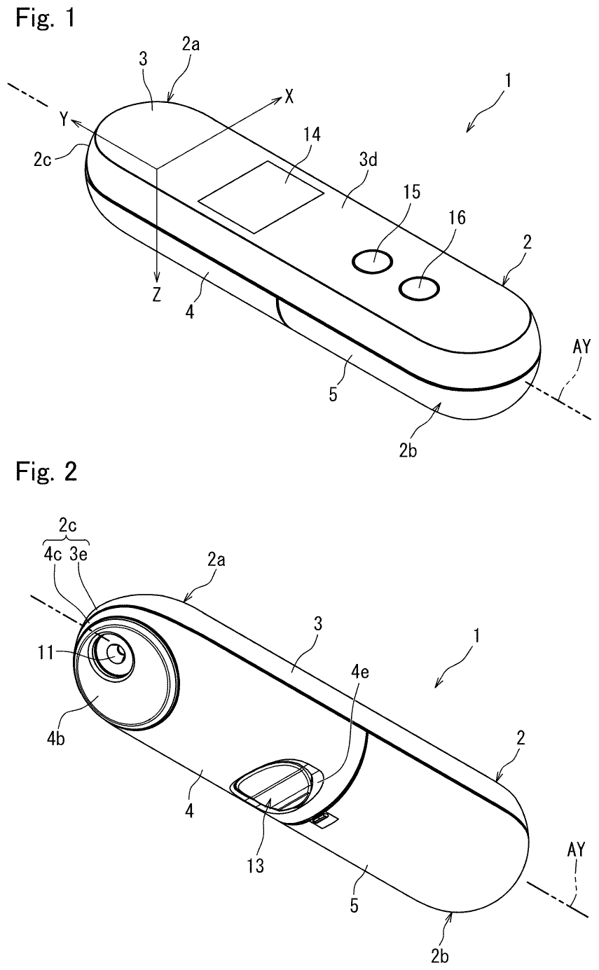

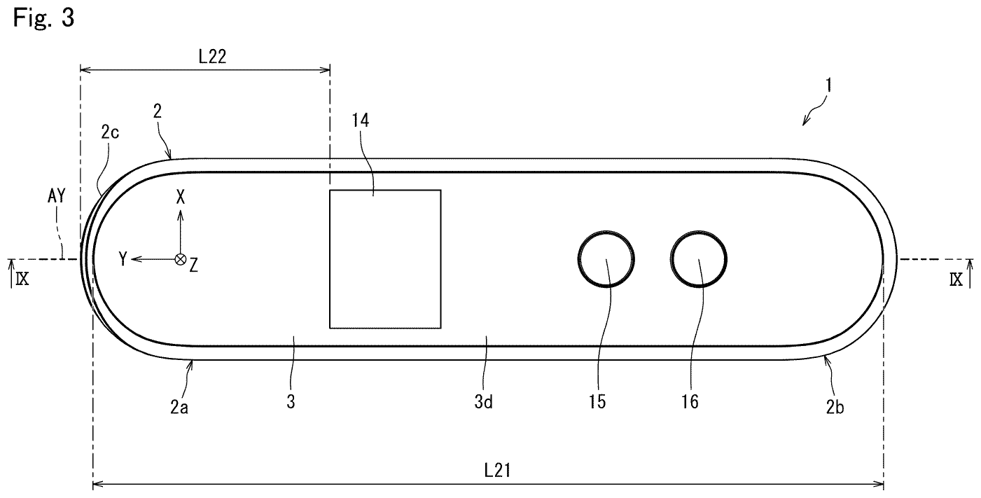

Next, a non-contact thermometer 1 according to an embodiment of the present invention will be described with reference to the accompanying drawings. In the following description, the XYZ coordinate system illustrated only in FIGS. 1 and 3 may be referred to. In this XYZ coordinate system, a longitudinal direction of the non-contact thermometer 1 having a rod-like overall shape is defined as a Y axis, a width direction of the non-contact thermometer 1 is defined as an X axis, and a thickness direction of the non-contact thermometer 1 is defined as a Z axis. The origin of the XYZ coordinate system is located on an axis AY described later. In the following description, the X′Y′Z′ coordinate system illustrated only in FIG. 7 may be referred to. In the X'Y'Z′ coordinate system, the center of the sensor surface 4b to be described later is set as the origin, an axis extending in the longitudinal direction of the non-contact thermometer 1 in the sensor surface 4b is set as the Y′ axis, an axis in the sensor surface 4b orthogonal to the Y′ axis is set as the X′ axis, and an axis perpendicular to the sensor surface 4b is set as the Z′ axis.

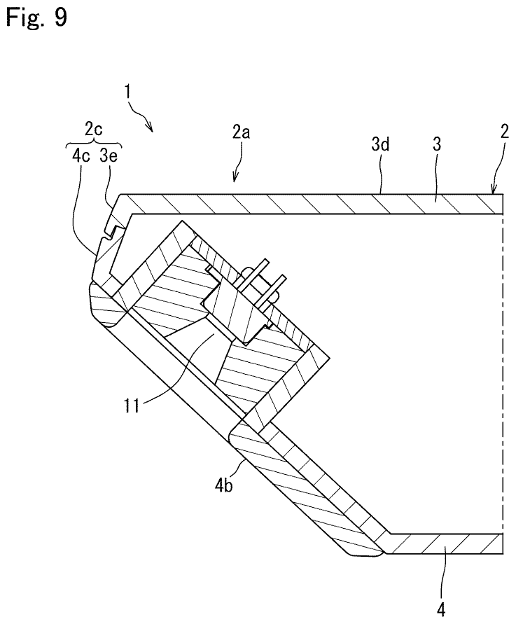

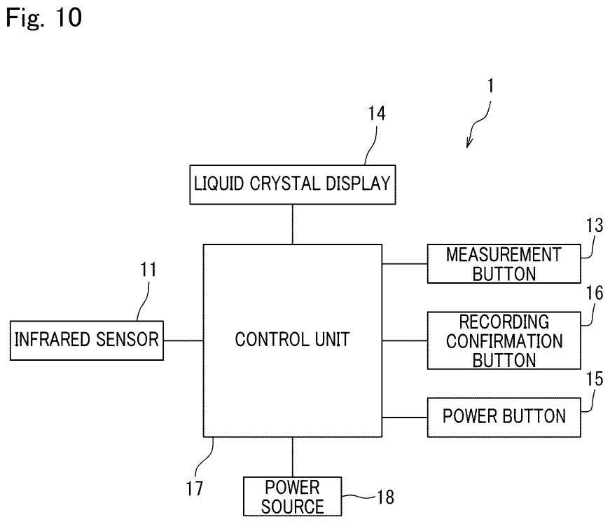

Referring to FIGS. 1 to 9, the non-contact thermometer 1 is a hand-held type having a forehead as a measurement site. The non-contact thermometer 1 includes an infrared sensor 11, a measurement button 13, a liquid crystal display (display unit) 14, a power button 15, and a storage confirmation button 16. The casing 2 of the non-contact thermometer 1 incorporates, in addition to the infrared sensor 11, a substrate on which various electric and electronic elements including a battery, a CPU, a memory, and a buzzer are mounted, a battery, and the like (all of which are not illustrated). The infrared sensor 11 detects infrared rays emitted from the measurement site, that is, the forehead of the subject in the present embodiment, and measures the body temperature of the subject based on the intensity of the detected infrared rays. Referring to FIG. 10, the control unit 17 (including the CPU and the memory described above) controls the operations of the infrared sensor 11, the liquid crystal display 14, and the power source 18 (including a battery in the present embodiment) according to the operations of the measurement button 13, the power button 15, and the recording confirmation button 16. That is, the control unit 17 includes a program for controlling the operation as a thermometer and a function as a storage unit in which a body temperature as a measured value is stored.

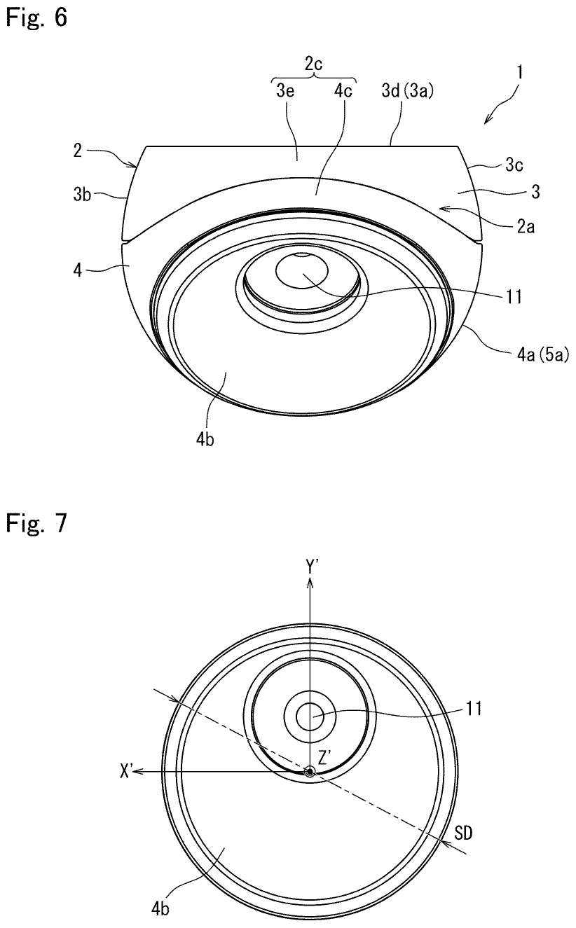

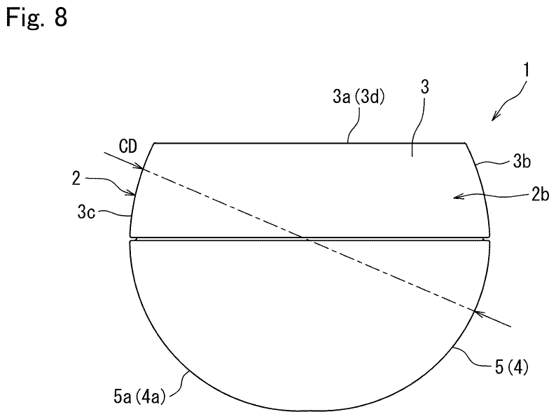

The casing 2 of the non-contact thermometer 1 has a rod shape extending along a virtual straight axis AY, and as shown most clearly in FIGS. 6 and 8, has a substantially constant outline in the direction in which the axis AY extends, that is, in the longitudinal direction (Y-axis direction) except for portions of a sensor surface 4b and a recess 4e to be described later. The casing 2 includes a fore end portion 2a with the built-in infrared sensor 11, and a base end portion 2b which is an end portion on the opposite side to the fore end portion 2a of the casing 2. Here, in regard to the casing 2, a rod shape means that a line connecting centroids of a plurality of cross sections orthogonal to the longitudinal direction of the casing is an axis AY that is a straight line.

The casing 2 in the present embodiment includes an upper casing 3, a lower casing 4, and a battery cover 5. The lower casing 4 extends from the fore end portion 2a toward the base end portion 2b of the casing 2, but does not reach the base end portion 2b and terminates halfway, and the battery cover 5 extends to the base end portion 2b. The lower casing 4 and the battery cover 5 face the upper casing 3 in the Z-axis direction. The battery cover 5 is detachable, and the battery housed in the casing 2 can be replaced by removing the battery cover 5. When the power source of the non-contact thermometer 1 is constituted by a rechargeable battery, it is not necessary to replace the battery, and thus the battery cover 5 is not necessary. Therefore, the lower casing 4 may have an integrated structure extending from the fore end portion 2a to the base end portion 2b.

Referring to FIGS. 6 and 8, the outline viewed from the direction in which the axis AY of the lower casing 4 and the battery cover 5 extends (the longitudinal direction, that is, the Y-axis direction) is constituted by partial arcs 4a and 5a except for a sensor surface 4b and a recess 4e in which the measurement button 13 is disposed, which will be described later. Further, referring to FIGS. 1 to 4, the fore end portion 2a side of the lower casing 4 is spherical except for a sensor surface 4b to be described later, and the base end portion 2b side of the battery cover 5 is also spherical.

Referring to FIGS. 2, 4 to 6, and 9, the fore end portion 2a of the casing 2 includes a foremost end portion 2c and a flat sensor surface 4b. The lower casing 4 is provided with the measurement button 13, and the upper casing 3 is provided with a liquid crystal display (display unit) 14, a power button 15, and a recording confirmation button 16.

Referring to FIGS. 1 and 2, the upper casing 3 extends from the fore end portion 2a to the base end portion 2b of the casing 2. Referring to FIGS. 6 and 8, the outline viewed from the direction in which the axis AY of the upper casing 3 extends is constituted by a straight line 3a and partial arcs 3b and 3c extending from both sides of the straight line 3a. That is, the upper casing 3 includes the flat portion 3d extending from the fore end portion 2a to the base end portion 2b.

The partial arcs 3b and 3c included in the outline of the upper casing 3 are continuous with the partial arcs 4a and 5a of the outline of the lower casing 4 and the battery cover 5, and the partial arcs 4a and 5a and the partial arcs 3b and 3c constitute one partial arc. Referring to FIGS. 1 to 4, both the fore end portion 2a side and the base end portion 2b side of the upper casing 3 are spherical except for the flat portion 3d.

In other words, the casing 2 has a shape in which a part of a cylinder having a hemisphere having the same diameter as the diameter of the cylinder attached to both ends thereof is cut off parallel to the axis AY, more specifically, parallel to the XY plane, and further has a shape in which a part of the fore end portion 2a is cut off as the sensor surface 4b while leaving the foremost end portion 2c. Details of the sensor surface 4b will be described later. The position where the casing 2 is cut off and the flat portion 3d is provided can be arbitrarily determined according to the size of the element or the like stored in the casing 2, but in the present embodiment, the height of the cut portion is preferably smaller than the radius of the cylinder. If the height of the cut portion is too large and the cut portion including the central axis of the cylinder is cut off, it is difficult to store various elements in the casing 2, it is difficult to secure the size of the sensor surface 4b to be described later, and the fore end portion 2c has a pointed shape.

As described above, the casing 2 excluding the sensor surface 4b and the recess 4e in the present embodiment has a shape (rod shape) in which the flat portion 3d is provided by cutting off a part of the cylinder having no bent portion along the longitudinal direction, and thus has a shape in which a part of the arc is cut off when the casing 2 is viewed from the direction in which the axis AY extends. However, the shape when viewed from the direction in which the axis AY extends before the flat portion 3d is provided in the casing 2 is not limited to a circle, and may be any shape such as an ellipse, a polygon, or a track shape. Further, the flat portion 3d is not provided in the casing 2, and the shape when viewed from the direction in which the axis AY extends may be a circle or other shape that is not partially cut. In addition, although the base end portion 2b in the present embodiment is substantially spherical, the base end portion 2b may be a plane perpendicular to the axis AY so that the non-contact thermometer 1 can be placed in a standing state on a table. Further, the casing 2 in the present embodiment has a shape obtained by cutting a cylinder having a uniform thickness, but the thickness of the casing 2 may change in the axis AY direction. For example, the casing 2 may be thick toward the fore end portion 2a or the base end portion 2b, or may be thick from the fore end portion 2a and the base end portion 2b toward the central portion. Furthermore, the outer shape of the casing 2 may not be linear but may be wavy. The area and the shape of the cross section orthogonal to the axis AY of the casing 2 may change continuously or discontinuously in the direction in which the axis AY extends.

The total length L11 of the casing 2 in the present embodiment may have a minimum value as long as various elements can be accommodated therein, and the maximum value can be appropriately set in consideration of installation and storage conditions at home and the like, and can be set to, for example, 300 mm with reference to a 30 cm ruler on the assumption of being stored together with stationery. More specifically, the total length L11 is defined by a length L12 from the center of the measurement button 13 to the foremost end portion 2c and a length L13 from the center of the measurement button 13 to the base end portion 2b. These lengths will be described later.

As the thickness of the casing 2 in the present embodiment, a diameter CD of a partial arc constituted by the partial arcs 4a and 5a and the partial arcs 3b and 3c can be used. The minimum value of the diameter CD may be any value as long as various elements can be accommodated therein, and the maximum value may be any value as long as the diameter CD can be gripped by the measurer. For example, under the assumption that the measurer is an elementary school student or more, the maximum value of the diameter CD can be set to 57.8 mm, which is twice the length of the arc length of a semicircle, that is, the inner diameter of the hand grip, with reference to the inner diameter of a Japanese 6-year-old child, that is, the average value of the inner diameters of the rings made of the thumb and the middle finger being 28.9 mm. A more preferable setting range for the diameter CD can be a range that the measurer can easily grip. As a specific example of a more preferable range of the diameter CD, for example, about 30 to 40 mm experimentally obtained as “thickness easy to grip” can be referred to. The diameter CD in the present embodiment is 37 mm.

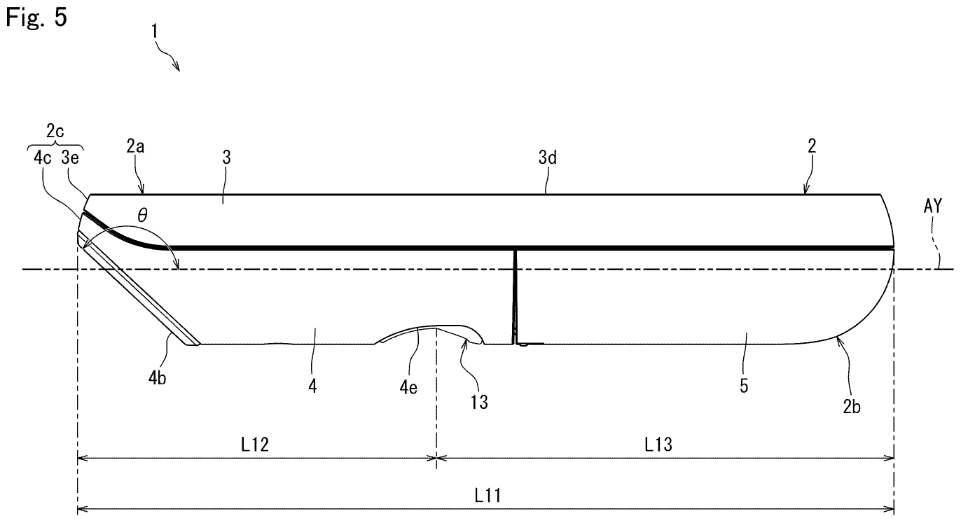

Referring to FIGS. 2, 4 to 6, and 9, the fore end portion 2a of the casing 2 includes a foremost end portion 2c and a flat sensor surface 4b. The foremost end portion 2c of the casing 2 is constituted by the foremost end portion 4c of the lower casing 4 which is spherical and the foremost end portion 3e of the upper casing 3 which is also spherical. The sensor surface 4b is provided in the lower casing 4 and extends from the foremost end portion 4c of the lower casing 4 toward the base end portion 2b of the casing 2 so as to be inclined at an angle θ with respect to the axis AY. In the present embodiment, the outer edge of the sensor surface 4b is circular. The diameter SD of the sensor surface 4b can be arbitrarily set to such an extent that the infrared sensor 11 can be accommodated and the sensor surface 4b positioned at the fore end of the casing 2 does not seem to have a pointed shape, for example, within a range not less than ½ of the diameter CD. As shown in FIG. 5, in the present embodiment, the division line between the upper casing 3 and the lower casing 4 is curved upward (on the side where the flat portion 3d is provided) in the side view at the fore end portion 2a and reaches substantially the middle of the foremost end portion 2c, so that the foremost end portion 2c is constituted by the foremost end portion 4c of the lower casing 4 and the foremost end portion 3e of the upper casing 3. However, due to the way of providing the flat portion 3d and the sensor surface 4b, manufacturing reasons, or the like, the foremost end portion 2c may be constituted by only a part of the upper casing 3 or only a part of the lower casing 4, and the end of the division line may: coincide with the upper end of the sensor surface 4b; be in the range where the sensor surface 4b is provided; coincide with the lower end of the sensor surface 4b; or be in a range below the sensor surface 4b. In addition, the lower end of the sensor surface 4b (in the cross-sectional view) in the present embodiment substantially coincides with the line of the lower end of the lower casing 4, that is, the sensor surface 4b reaches the lower end of the casing 2 in the side view. However, the lower end of the sensor surface 4b (in the cross-sectional view) may be located above the lower end of the lower casing 4 in the side view. Furthermore, in the present embodiment, the sensor surface 4b is configured by attaching a separate member to the lower casing 4, but the sensor surface 4b may not be configured by a separate member and may be formed as a part of at least one of the upper casing 3 and the lower casing 4.

Referring to FIGS. 2, 4, 6, 7, and 9, the infrared sensor 11 is accommodated in the casing 2 so as to directly face the sensor surface 4b, that is, so that the direction of the infrared sensor 11 coincides with the direction of the normal line (Z′ axis) of the sensor surface 4b. Referring to FIG. 7, when the sensor surface 4b in the present embodiment is viewed from the front, most of the infrared sensor 11 is located on one side (upper side in FIG. 7) in the Y′ axis direction with respect to the center of the sensor surface 4b, that is, the center of the X′Y′Z′ coordinate system, that is, the center of the infrared sensor 11 is located on the plus side of the Y′ axis.

Referring to FIGS. 2, 4, and 5, the casing 2 is provided with the measurement button 13 on the opposite side to the flat portion 3b with respect to the axis AY, and thus on the same side as the sensor surface 4b in a side view (FIG. 5). The fact that the measurement button 13 is provided on the same side of the casing 2 as the sensor surface 4b in a side view means that the measurement button 13 is aligned with the most base end portion 2b side of the sensor surface 4b in the direction in which the axis AY extends when the casing 2 is viewed from the side, and is not limited to a case where the measurement button 13 and the most base end portion 2b side of the sensor surface 4b are located on one straight line parallel to the axis AY. A case where these positions in the direction orthogonal to the axis AY are different is also encompassed. More specifically, in the lower casing 4, a recess 4e having a circular shape in a facing view is formed by hollowing out a part of the lower casing 4, that is, the recess 4e has concave shape in a side view. The measurement button 13 having a circular shape in a facing view is disposed in the recess 4e. The measurement button 13 has a concave shape in a side view similarly to the recess 4e. In the present embodiment, the side view shape of the measurement button 13 is generally constituted by a part of the cylindrical surface extending in the X-axis direction, but the side view shape of the measurement button 13 may be a curved surface having a smaller curvature radius on the base end portion 2b side than the fore end portion 2a side, or may be a flat surface. In addition, without providing the recess 4e, the measurement button 13 may be seen integrally with the lower casing 4 in side view, or the measurement button 13 may protrude downward from the lower casing 4 in side view. In addition, from the viewpoint of convenience of operation by the measurer, a rib may be provided on the edge of the measurement button 13 on the base end portion 2b side, or the surface of the measurement button 13 may be made of a material having a higher frictional resistance.

In the casing 2 in the present embodiment, the liquid crystal display (display unit) 14, the power button 15, and the recording confirmation button 16 are arranged in the flat portion 3b of the upper casing 3 so as to be aligned in the longitudinal direction (Y-axis direction) of the casing 2. Specifically, the liquid crystal display 14 is located on the fore end portion 2a side with respect to the center in the longitudinal direction of the casing 2, and the power button 15 and the recording confirmation button 16 are aligned in the longitudinal direction on the base end portion 2b side with respect to the liquid crystal display 14. The arrangement and order of the liquid crystal display 14, the power button 15, and the recording confirmation button 16 are not limited thereto, and the power button 15 and the recording confirmation button 16 may be arranged side by side (that is, aligned in the X-axis direction) on the flat portion 3b, and either or both of the power button 15 and the recording confirmation button 16 may be arranged not on the flat portion 3b but at any place on the casing 2, for example, on a side surface of the casing 2 within a range in which there is no confusion with the measurement button 13.

By pressing the recording confirmation button 16 before the start of the measurement or after the completion of the measurement, the past measurement result can be called from the storage unit included in the control unit 17 and displayed on the liquid crystal display 14. For example, in a case where the storage unit can hold measurement records of the past five times, the measurement results of the previous one to the previous five times are sequentially displayed in this order every time the recording confirmation button 16 is pressed before the measurement, and the measurement results of the previous four times from the current measurement result are sequentially displayed in this order every time the recording confirmation button 16 is pressed after the measurement. In addition, in a case where the non-contact thermometer 1 has a function of transmitting a measurement result to an external terminal such as a smartphone, the transmission function may be activated in parallel with reading and display of recording at the timing when the recording confirmation button 16 is pressed once, and the stored measurement value may be entirely transmitted to the external terminal.

In the temperature measurement using the non-contact thermometer 1 of the present embodiment, the measurer first presses the power button 15 to turn on the power of the non-contact thermometer 1 in both cases of temperature measurement of another person and temperature measurement of oneself. Subsequently, the measurer grips the casing 2 of the non-contact thermometer 1 and adjusts the sensor surface 4b to an appropriate positional relationship, angle, and distance with respect to the forehead which is the measurement surface. Thereafter, the measurer presses the measurement button 13 to execute temperature measurement (body temperature measurement). The procedure of temperature measurement is not limited to this, and for example, after pressing the power button 15 to turn on the power of the non-contact thermometer 1, the measurer may hold the casing 2 of the non-contact thermometer 1 while pressing the measurement button 13, adjust the sensor surface 4b to an appropriate positional relationship, angle, and distance with respect to the forehead which is the measurement surface, and thereafter, perform temperature measurement by releasing the finger from the measurement button 13. In the following description, the description of the pressing operation of the power button 15 for turning on the power is omitted.

As described above, since the sensor surface 4b has a shape in which the fore end portion 2a of the casing 2 is cut off with an inclination with respect to the axis AY while leaving the foremost end portion 2c, the inclination angle θ of the sensor surface 4b with respect to the axis AY illustrated in FIG. 5 is more than 90 degrees and less than 180 degrees. In addition, since the sensor surface 4b is obtained by cutting off the fore end portion 2a of the casing 2 having a hemispherical shape while leaving the foremost end portion 2c, the upper end portion of the sensor surface 4b in the side view does not reach the flat surface 3d. Assuming that the upper end portion of the sensor surface 4b in the side view reaches the flat surface 3d, the flat surface 3d is a portion cut parallel to the axis AY, and the line to be the lower end of the lower casing 4 and the battery cover 5 in the side view is parallel to the axis AY, and the sensor surface 4b is inclined at an angle θ with respect to the axis AY. Therefore, the angle formed by the sensor surface 4b whose upper end reaches the flat portion 3d and the flat portion 3d is an angle obtained by subtracting θ from 180 degrees. As described above, since θ is more than 90 degrees and less than 180 degrees, that is, an obtuse angle, an angle obtained by subtracting θ from 180 degrees is an acute angle. That is, when the upper end portion of the sensor surface 4b reaches the flat surface 3d, a portion where the angle formed by the surfaces is an acute angle is formed in the fore end portion 2a of the casing 2, and a pointed portion is formed in the fore end portion 2a. In the case of the temperature measurement by the non-contact thermometer having such a shape, since the rod-shaped object having a pointed end is pointed at the subject's forehead, the subject may feel a sense of unpleasantness or a sense of discomfort. In the casing 2 of the present embodiment, since the foremost end portion 2c which is a part of the sphere exists between the upper end of the sensor surface 4b and the flat portion 3d, the fore end portion 2a does not have a pointed shape. Therefore, a sense of unpleasantness or a sense of discomfort is reduced as compared with a case where the pointed end is pointed at the face.

In both cases of the temperature measurement of another person and the temperature measurement of oneself, the measurer obliquely grips the casing 2 and points the fore end portion 2a at another person's forehead or one's own forehead. The inclination angle θ of the sensor surface 4b with respect to the axis AY can be arbitrarily set in a range of more than 90 degrees and less than 180 degrees, but preferably, the range of the inclination angle θ may be set in such a range that the sensor surface 4b directly faces the forehead when the measurer who naturally grips the casing 2 obliquely without particular attention points the fore end portion 2a at the forehead of another person or oneself. Here, in a case where the measurer obliquely grasps the rod-shaped object, unless otherwise specified, the angle of the rod-shaped object that is naturally grasped without particular consciousness is often about 45 degrees from the horizontal plane. Therefore, the angle of the axis AY of the casing 2 gripped obliquely with respect to the horizontal plane is also around 45 degrees, and the inclination angle of the sensor surface 4b with respect to the axis AY for making the angle perpendicular to the horizontal plane is 135 degrees. Here, since the forehead is slightly inclined backward, it is preferable to increase the angle of the sensor surface 4b with respect to the axis AY by that amount. Specifically, assuming a range in which the forehead is inclined backward by about 15 degrees from a right angle with respect to the horizontal plane, it is preferable to set the inclination angle θ corresponding thereto to 135 degrees or more and 150 degrees or less. In the present embodiment, the inclination angle θ is set to 142 degrees.

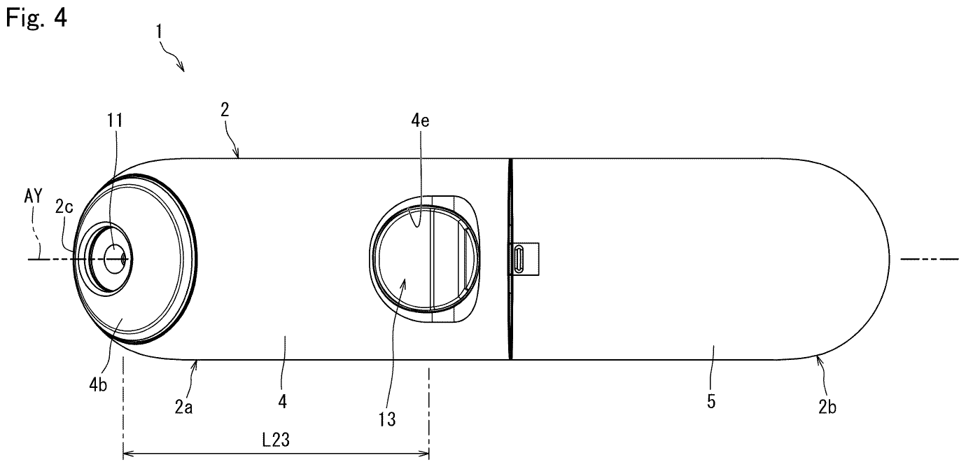

Referring to FIG. 4, the center of the measurement button 13 in the X-axis direction coincides with the axis AY, that is, the measurement button is bilaterally symmetrical with respect to the casing 2 together with the sensor surface 4b and the infrared sensor 11. Therefore, it is possible to suitably measure regardless of whether the measurer uses the right hand or the left hand for measurement.

Since the measurement button 13 is provided on the same side as the sensor surface 4b in a side view, when the casing 2 is gripped such that the sensor surface 4b faces the subject at the time of temperature measurement of another person, the measurement button 13 is also located on the subject side, that is, the side far from the measurer. In addition, since the sensor surface 4b is provided to be inclined at the angle θ with respect to the axis AY of the casing 2, the measurer who intends to point the sensor surface 4b at the forehead of the subject obliquely grips the casing 2 at an angle corresponding to the inclination angle θ of the sensor surface 4b. In this case, the measurer who intends to press the measurement button 13 on the side far from the measurer himself/herself with the entire casing 2 in the oblique posture presses the measurement button 13 with the index finger or the middle finger, and grips the casing 2 so as to bring at least a part of the thumb into contact with the flat surface 3d.

The portion close to the fore end side of the casing 2 gripped in this manner protrudes toward the subject from between the thumb and the index finger of the measurer regardless of whether the finger operating the measurement button 13 is the index finger or the middle finger. At this time, when the size of each fingertip is ignored, on the sensor surface 4b side, the length of the protruding portion coincides with the length L12 from the center of the measurement button 13 in the axis AY direction to the foremost end portion 2c of the casing 2 when the measurement button 13 is operated with the index finger, and coincides with the length obtained by subtracting the length from the center of the measurement button 13 to the position where the index finger is in contact with the casing 2 from the length L12 from the center of the measurement button 13 in the axis AY direction to the foremost end portion 2c of the casing 2 when the measurement button 13 is operated with the middle finger.

Here, in a case where the entire weight of the non-contact thermometer 1 is sufficiently light with respect to the muscle strength of the measurer, or the like, it is conceivable that the measurer grips the casing 2 of the non-contact thermometer 1 so as to hold the casing 2 only with the thumb and the index finger or the middle finger. However, in general, for maintaining the posture of the casing 2 and convenience of measurement operation, it is conceivable that the measurer grips the casing 2 using other fingers or a palm, a wrist, a part of the forearm, or the like in addition to the thumb and the finger operating the measurement button 13. When another finger is used, regardless of whether the finger operating the measurement button 13 is the index finger or the middle finger, the posture of the finger of the measurer with respect to the casing 2 (that is, the positional relationship of each finger) is the same. Therefore, in the description of the measurement posture of the finger at the time of temperature measurement of another person, the finger operating the measurement button 13 will be described as the index finger.

In a case where the length L13 in the direction from the center of the measurement button 13 toward the base end portion 2b of the casing 2 is long with respect to the size of the palm of the measurer, the measurer who intends to perform the temperature measurement of another person can hold the casing 2 can grip the casing 2 in either of: a manner in which the middle finger, the ring finger, and the little finger are arranged to be substantially aligned and wrapped around the lower casing 4 and the battery cover 5 of the casing 2, and a portion of the casing 2 closer to the base end portion 2b with respect to the little finger is not brought into contact with another portion of the body of the measurer; and a manner in which the middle finger, the ring finger, and the little finger are arranged to be substantially aligned and wound around the lower casing 4 and the battery cover 5 of the casing 2, or the fingertips of these fingers are arranged along the central axes of the lower casing 4 and the battery cover 5, and at least one point of the portion of the portion closer to the base end portion 2b with respect to the little finger is brought into contact with a portion of the palm on the little finger side, the wrist, or the forearm.

In a case where the length L13 in the direction from the center of the measurement button 13 toward the base end portion 2b of the casing 2 is shorter than the size of the palm of the measurer, the measurer who intends to perform temperature measurement of another person can hold the casing 2 in a mode in which a part of the base end portion 2b of the casing 2 is brought into contact with the inside of the palm to support the casing 2 and the middle finger, the ring finger, and the little finger take arbitrary postures.

Since the measurement button 13 is provided on the same side as the sensor surface 4b in a side view, at the time of the temperature measurement of oneself, when the casing 2 is gripped such that the sensor surface 4b faces the measurer as the subject, the measurement button 13 is also located on the side close to the measurer which is the subject side. In addition, since the sensor surface 4b is provided to be inclined at the angle θ with respect to the axis AY of the casing 2, the measurer who intends to point the sensor surface 4b at one's forehead as the subject obliquely grips the casing 2 at an angle corresponding to the inclination angle θ of the sensor surface 4b. In this case, the measurer who intends to press the measurement button 13 on the side close to the measurer himself/herself with the entire casing 2 in the oblique posture grips the casing 2 so as to put the thumb on the measurement button 13 and bring at least a part of the index finger or the middle finger into contact with the flat surface 3d.

The portion close to the fore end side of the casing 2 gripped in this manner protrudes from between the thumb and the index finger of the measurer toward the measurer himself who is the subject. At this time, when the size of the fingertip of the thumb is ignored, the length of the protruding portion coincides with a length L12 from the center of the measurement button 13 in the axis AY direction to the foremost end portion 2c of the casing 2 on the sensor surface 4b side.

In the following description, it is assumed that a measurer who measures his/her own temperature grips the casing 2 using not only the thumb and the two fingers of the index finger or the middle finger but also other fingers, a palm, a wrist, a part of the forearm, and the like, as in the case of another person's temperature measurement.

In a case where the length L13 in the direction from the center of the measurement button 13 toward the base end portion 2b of the casing 2 is long with respect to the size of the palm of the measurer, the base end portion 2b side of the casing 2 extends in a direction away from the measurer at the time of his/her own temperature measurement. Therefore, the measurer who intends to perform his/her own temperature measurement can grip the casing 2 in such a manner that the middle finger, the ring finger, and the little finger are wrapped around the upper casing 3 of the casing 2 in a substantially aligned manner, or the fingertips of these fingers are arranged to be in contact with the flat surface 3d of the upper casing 3 side by side, and a portion close to the base end portion 2b of the casing 2 protrudes from the little finger side of the palm of the measurer. In this case, a part of the side surface closer to the base end portion 2b than the little finger of the gripped casing 2 may or may not be brought into contact with the part closer to the little finger of the palm.

In addition, in a case where the length L13 in the direction from the center of the measurement button 13 toward the base end portion 2b of the casing 2 is short with respect to the size of the palm of the measurer, the measurer who intends to measure his/her own temperature can bring a part of the base end portion 2b of the casing 2 into contact with the inside of the palm while supporting the casing 2 with the thumb placed on the measurement button 13 and the index finger arranged on the flat surface 3d, and bring the middle finger, the ring finger, and the little finger into an arbitrary posture, or can bring a point of the base end portion 2b of the casing 2, which is farthest from the fore end portion, into contact with the vicinity of the center of the palm, and can grip the casing 2 in such a manner that the index finger, the middle finger, the ring finger, and the little finger are arranged side by side along the partial arc 3b, the straight line 3a, and the partial arc 3c when viewed from the fore end portion 2a.

As described above, in the casing 2 of the non-contact thermometer 1 of the present embodiment, the fore end portion 2a side of the casing 2 protrudes from between the thumb and the index finger of the measurer, and the length of the protruding portion can be described using the length L12 from the center of the measurement button 13 in the axis AY direction to the foremost end portion 2c of the casing 2, both at the time of the temperature measurement of another person and at the time of the temperature measurement of oneself. The length L12 can be arbitrarily set, and more preferably, may be in such a range that adjustment of the positional relationship between the sensor surface 4b and the forehead is facilitated and a sense of discomfort at the time of measurement is reduced.

In a case where L12 is long, that is, in a case where the position of the measurement button 13 is away from the sensor surface 4b, it is difficult to perform alignment particularly in the self-temperature measurement. That is, since the forehead which is the measurement surface is above the eyes, it is difficult for the measurer who intends to measure his/her own temperature to visually observe the sensor surface 4b close to his/her own forehead. Therefore, the measurer needs to adjust the positional relationship between the forehead and the sensor surface 4b using another adjustment method, for example, a method of adjusting the positional relationship between the forehead and the sensor surface 4b indirectly by visually observing the portion other than the sensor surface 4b and adjusting the positional relationship between the portion and the face of the measurer.

When the measurement button 13 is located away from the sensor surface 4b, the thumb placed on the measurement button 13 is located below the eye level of the measurer. Therefore, when the measurer directs his/her eyes to the front, only an empty portion of the lower casing 4 is visible, and it is difficult to perform alignment by visually observing a portion other than the sensor surface 4b of the casing 2. In addition, at this time, in order to indirectly adjust the positional relationship between the forehead and the sensor surface 4b by visually observing the thumb put on the measurement button 13, it is necessary to direct the line of sight downward while maintaining the posture of the head in order to visually observe the thumb. Therefore, the burden on the measurer is high.

In a case where L12 is short, that is, in a case where the position of the measurement button 13 is close to the sensor surface 4b, there is a risk that the index finger of the measurer who tries to operate the measurement button 13 with the middle finger hits the infrared sensor 11 at the time of temperature measurement of another person. In addition, when the measurer who places the index finger or the middle finger on the measurement button 13 provided at a position close to the sensor surface 4b brings the fore end portion 2a of the casing 2 close to the forehead of the subject, a part of the index finger or the middle finger protrudes to the side of the subject from the sensor surface 4b and approaches the face of the subject with the height of the eyes of the subject, and a sense of unpleasantness or a sense of discomfort as if the subject is thrust with a fist may occur.

In a case where the measurement button 13 is at such a position that the thumb placed on the measurement button 13 is in front of the eyes of the measurer at the time of the temperature measurement of oneself, the measurer can indirectly adjust the positional relationship between the forehead and the sensor surface 4b by visually observing the thumb. At this time, since the infrared sensor 11 is disposed above the sensor surface 4b, referring to FIG. 4, it is preferable that the length obtained by multiplying the length L23 between the infrared sensor 11 and the center of the measurement button 13 by the sine of the angle of the axis AY from the horizontal line when the casing 2 is obliquely gripped approximates to the distance in the vertical direction from the eyes of the measurer (subject) to the center of the forehead, since the positional relationship between the forehead and the sensor surface 4b can be easily adjusted.

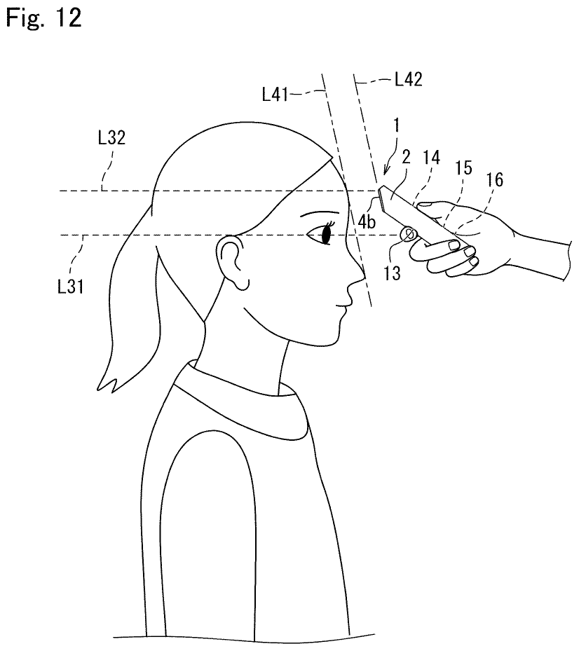

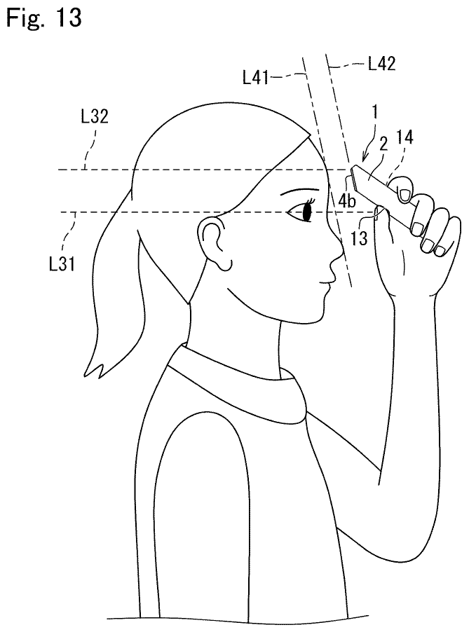

Hereinafter, the range of L12 will be described in more detail assuming the temperature measurement of oneself. The shape of the human head varies depending on race and age, and variation between individuals is large, but a portion above the height of the eyes (L31 in FIGS. 12 and 13) can be approximated to a hemispherical shape. Since the average of Japanese adult men is 575.9 mm for the head circumference, which is the circumferential length of the hemisphere, it is assumed that the head circumference of a person who measures himself/herself is in a range of approximately up to 600 mm. In a side view of the head, the portion above the height of the eyes including the forehead is substantially semicircular, and the angle of the tangential plane of the forehead at the center of the forehead, which is the portion above the eyes, is inclined backward than the vertical. The forehead generally refers to a range from the hairline to the eyebrow. The hairline is closer to the eyes than to the top of the head, and the eyebrow is closer to the top of the head than the eyes, that is, the forehead can be described as a further partial range of the front half in the semicircle in which the upper side of the head is viewed from the side. Here, assuming a height at which the angle from the center of the head is about 45 degrees, that is, a length of about 0.7 times the radius as the height (L32 in FIGS. 12 and 13) of the center of the forehead, it is preferable to assume a distance of about 0.7 times the radius corresponding to the circumferential length of 600 mm, that is, up to about 67 mm as the distance between the height L31 of the eyes and the height L32 of the center of the forehead. As described above, since the height is a length obtained by multiplying L23 by the sine of the angle of the axis AY of the casing 2 from the horizontal line, when the angle of the axis AY of the casing 2 is 45 degrees, L23 can be set in a range up to 95 mm, and L12 can be set up to about 100 mm in consideration of the mounting position of the infrared sensor 11 in the sensor surface 4b. In the present embodiment, L12 is 72 mm.

In addition, the length L13 of the casing 2 of the non-contact thermometer 1 of the present embodiment on the base end portion 2b side can be arbitrarily set, but the length enabling the casing 2 to be stably gripped at the time of body temperature measurement is preferable. When the length L13 is short and the four fingers other than the thumb cannot be put on, stability of the grip is poor. Therefore, the length L13 is preferably 60 mm or more with reference to 59.5 mm, which is the sum of the average widths of the first joint portions of the four fingers other than the thumb of Japanese adult males.

In addition, since it is easier to adjust and maintain the posture of the gripped casing 2 when the base end portion 2b side is in contact with the palm than when the base end portion 2b protrudes from the little finger side of the hand of the measurer, the maximum value of L13 can be set to 123.9 mm using, for example, 71.1 mm which is the average value of the length of the index finger of Japanese adult males and 52.8 mm which is ½ of the average value of the length from the wrist to the base of the middle finger of Japanese adult males, so that the position of the base end portion 2b is located inside the palm while the casing 2 is gripped with the thumb or the index finger. In the present embodiment, L13 is 85 mm.

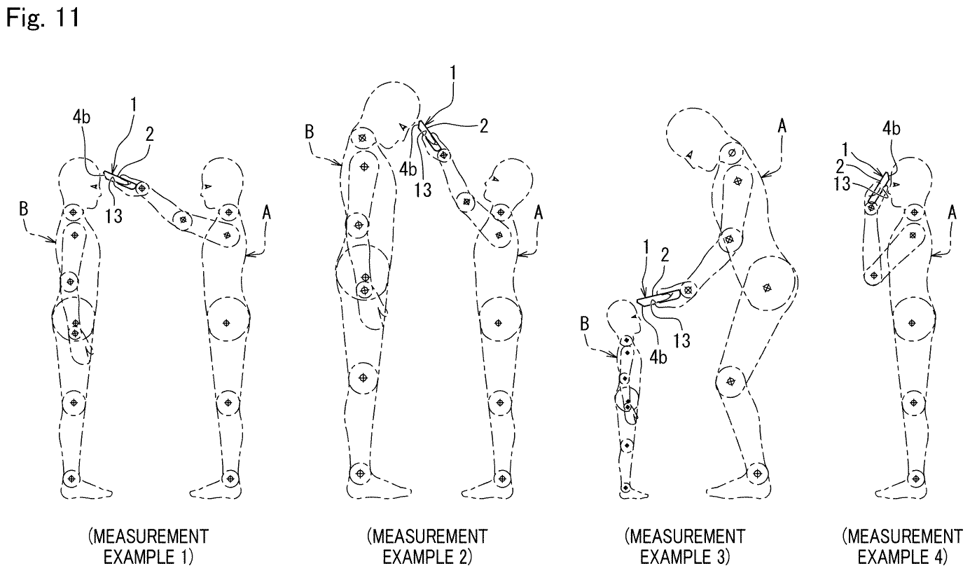

Describing in detail the case of another person's temperature measurement (measurement examples 1 to 3 in FIG. 11, and FIG. 12), a measurer A places an index finger on the measurement button 13, holds the casing 2 between the index finger and the thumb, and grips the non-contact thermometer 1 in a state where the base end portion 2b of the casing 2 is in contact with the palm. Then, the measurer A can point the sensor surface 4b at the forehead of the subject B by naturally extending the arm toward the subject B while holding the casing 2. Measurement example 1 is a case where there is no height difference between the measurer A and the subject B. At this time, the measurer A grips the casing 2 obliquely upward, and the elbow joint is bent while the forearm extends obliquely upward, that is, the angle of the arm of the measurer A has a margin, and the measurement posture is reasonable. Measurement example 3 is a case where the measurer A is taller than the subject B in height. At this time, the measurer A extends one's arm downward, and grips the casing 2 at an angle close to horizontal using the wrist in accordance with the angle of the face of the subject B facing upward. When the arm is extended downward, the index finger is positioned below the thumb. Therefore, the measurer A who puts the index finger on the measurement button 13 can easily adjust the angle of the casing 2 around the index finger.

Measurement example 2 is a case where the standing height of the measurer A is considerably lower than the standing height of the subject B, and the arm needs to be extended upward. When the height difference is large, the measurer needs to fully extend the elbow joint, and at this time, the thumb along the flat surface 3d is also extended. If the measurement button is on the flat surface 3d side, since the button is operated with the fully extended thumb, there is a possibility that the arm and the finger feel tightness and pain. However, since the measurement button 13 of the present embodiment is on the sensor surface 4b side, the button operation can be performed with the bent index finger. Meanwhile, the joint of the thumb is loosened within such a range that the measurement button 13 can be operated with the index finger, and the thumb is brought into contact with the base end portion 2b side than in the fully extended state, whereby the sensor surface 4b can be pointed at the forehead of the subject B without feeling of tightness of the arm and the finger. That is, by making the position of the measurement button 13 on the same side as the sensor surface 4b, the measurer A can perform measurement in a reasonable posture.

Describing in detail the case of temperature measurement of oneself (measurement example 4 in FIG. 11, and FIG. 13), the measurer A places a thumb on the measurement button 13, holds the casing 2 between the thumb and the index finger, and grips the non-contact thermometer 1 in a state where the base end portion 2b of the casing 2 is in contact with the palm. Then, the measurer A naturally bends the arm while holding the casing 2, and gazes at the thumb placed on the measurement button 13. At this time, the height of the thumb is at the height of the eyes, the left and right positions with respect to the face are near the center, and the distance between the eyes and the thumb is often 50 mm or more at which the thumb can be visually observed with both eyes without effort such as crossing eyes. In addition, the angle of the forearm is substantially a right angle, and the sensor surface 4b can be pointed at the one's own forehead without bending the palm with respect to the forearm. Furthermore, since the position of the elbow is slightly anterior to the chest, the upper arm and the forearm do not become tight.

Referring to FIGS. 1, 2, and 12, at the time of another person's temperature measurement (measurement example 1 to 3 in FIG. 11), the measurer A adjusts the position and posture of the casing 2 of the non-contact thermometer 1 in the power-on state such that the sensor surface 4b has an appropriate positional relationship, angle, and distance with respect to the forehead of the subject B, which is the measurement surface, and then presses the measurement button 13 with the index finger. Alternatively, referring to FIGS. 1, 2, and 13, at the time of temperature measurement of oneself (measurement example 4 in FIG. 11), the measurer A adjusts the position and posture of the casing 2 of the non-contact thermometer 1 in the power-on state such that the sensor surface 4b has an appropriate positional relationship, angle, and distance with respect to the forehead of the measurer A him/herself, which is the measurement surface, and then presses the measurement button 13 with the thumb. Hereinafter, adjustment of the positional relationship between the sensor surface 4b and the measurement surface will be described in detail.

In general, in an infrared sensor adopted in a non-contact thermometer, a measurement range is a surface, and the measurement range increases as a distance from the infrared sensor increases. In addition, when an object other than the object is included in the measurement range, the temperature of the object other than the object is also measured. Therefore, the measurement range needs to be sufficiently small with respect to the object. In the temperature measurement by the infrared sensor, measurement can be performed even if the infrared sensor is inclined with respect to the object (measurement surface), but since the shape of the measurement range is elliptical, there is a high possibility that an object other than the object is included in the measurement range depending on the distance and angle, and this possibility is further increased when the object (measurement surface) is a spherical surface. For this reason, in the non-contact thermometer using the infrared sensor, it is necessary to point the infrared sensor at the center of the measurement surface and to cause the infrared sensor to directly face the measurement surface in a certain distance range in order to ensure accuracy required for body temperature measurement.

That is, in the temperature measurement by the hand-held type non-contact thermometer with the forehead as the measurement site, it is necessary to point the infrared sensor at the center of the forehead as the measurement surface and cause the infrared sensor to substantially directly face the forehead as the measurement surface (that is, the direction of the infrared sensor substantially coincides with the normal line of the tangential plane of the forehead in the vicinity of the center of the forehead) in a certain distance range so that the entire measurement range of the infrared sensor is included in the forehead. The certain distance range may vary depending on the characteristics of the employed infrared sensor, but is generally a range within 10 cm in many cases. Since the infrared sensor 11 according to the present embodiment is disposed so as to face the sensor surface 4b, in the non-contact thermometer according to the present embodiment, causing the infrared sensor 11 to substantially directly face the forehead means causing the sensor surface 4b to substantially directly face the forehead, in other words, causing the tangential plane between the sensor surface 4b and the forehead to be substantially parallel. Note that the center of the forehead includes both the center in the vertical direction and the center in the horizontal direction, but the center in the horizontal direction in the forehead is the center of the face, and the measurement button 13 of the present embodiment is provided at the center with respect to the width direction of the casing 2. Therefore, the center in the vertical direction will be described in the following description.

Referring to FIGS. 12 and 13, when the infrared sensor 11 is pointed at the center of the forehead which is the measurement surface, the height of the infrared sensor 11 is the height of a line L32 representing the height of the center of the forehead. In addition, when the infrared sensor 11 is caused to face the forehead, a line L41 representing the tangential plane of the forehead and a line L42 representing the sensor surface are parallel. Furthermore, the distance between the forehead and the infrared sensor 11 can be expressed by a distance between L41 and L42.

Referring to FIG. 12, the measurer holding the casing 2 of the non-contact thermometer 1 obliquely adjusts the position, angle, and distance of the sensor surface 4b to be appropriate for the forehead of the subject at the time of temperature measurement of another person. Specifically, the measurer adjusts the position and distance of the sensor surface 4b by visually observing the portion of the flat surface 3d included in the fore end portion 2a. As for the angle, the measurer cannot directly visually observe the sensor surface 4b, but since the sensor surface 4b is provided to be inclined with respect to the axis AY of the rod-shaped casing 2, the sensor surface 4b naturally faces the forehead of the subject, that is, easily faces the forehead of the subject in a state where the casing 2 is obliquely gripped.

Referring to FIG. 13, the measurer holding the casing 2 of the non-contact thermometer 1 obliquely adjusts the position, angle, and distance of the sensor surface 4b so as to be appropriate for his/her own forehead which is the subject at the time of temperature measurement of oneself. Specifically, since the measurer cannot adjust the position, angle, and distance by directly visually observing the sensor surface 4b, the measurer indirectly adjusts the position and distance of the sensor surface 4b by visually observing the thumb put on the measurement button 13 and adjusting the position and distance of the thumb. In the example of FIG. 3, the position of the thumb is adjusted to the eye height position (indicated by line L31). As for the angle, the measurer cannot directly visually observe the sensor surface 4b, and it is difficult to visually observe the angle of the casing 2. However, since the sensor surface 4b is provided to be inclined with respect to the axis AY of the rod-shaped casing 2, the sensor surface 4b naturally faces, that is, easily faces the subject's own forehead due to the casing 2 being held obliquely with the thumb substantially vertical.

In the non-contact thermometer 1 of the present embodiment, the casing 2 has a rod shape, the sensor surface 4b has a flat shape extending obliquely with respect to the axis AY, and the measurement button 13 is provided on the same side as the sensor surface 4b in a side view. Therefore, by holding the casing 2 such that the index finger touches the measurement button 13 at the time of measurement of another person, the sensor surface 4b is easily pointed at one's own forehead which is the measurement site, and alignment of the sensor surface 4b with respect to the forehead of the subject and adjustment of the distance are facilitated.

In the non-contact thermometer 1 of the present embodiment, the casing 2 has a rod shape, the sensor surface 4b has a flat shape extending obliquely with respect to the axis AY, and the measurement button 13 is provided on the same side as the sensor surface 4b in a side view. Therefore, by holding the casing such that the thumb is placed on the measurement button 13 at the time of measurement by the user, the sensor surface 4b is easily pointed at one's own forehead which is the measurement site, and by visually observing the thumb placed on the measurement button 13, alignment of the sensor surface 4b with respect to one's own forehead and adjustment of the distance are facilitated.

In addition, since the measurement button 13 is provided on the same side of the casing 2 as the sensor surface 4b, the sensor surface 4b can be pointed at the forehead with a finger placed on the measurement button 13 for both cases of the temperature measurement of another person and the temperature measurement of oneself. In particular, since the sensor surface 4b is provided at the fore end portion of the rod-shaped casing 2 and the measurement button 13 is provided on the same side as the sensor surface 4b in the casing 2, in both cases of the temperature measurement of another person and the temperature measurement of oneself, it is possible to perform the temperature measurement with the arms, the elbows, and the wrists in reasonable postures even when there is a significant height difference between the measurer and the subject, or the temperature measurement of the subject standing beside the seated measurer is performed.

Since the casing 2 has a rod shape, in both cases of: the temperature measurement of another person where a subject B's forehead is pointed with the sensor surface 4b and thus the fore end portion 2a of the casing 2 by the measurer A; and the temperature measurement of oneself where the measurer A's forehead is pointed with the fore end portion 2a of the casing 2 by oneself, a sense of unpleasantness or a sense of discomfort is reduced as compared with the case where a pistol-shaped object is pointed at the face.

The fore end portion 2a of the casing 2 does not have a pointed shape, since it is not formed only of the inclined surface, and includes the foremost end portion 2c and the flat sensor surface 4b extending obliquely from the foremost end portion 2c. The foremost end portion 2c has a spherical shape. Therefore, in both cases of: the temperature measurement of another person where the subject B's forehead is pointed with the fore end portion 2a of the casing 2 by the measurer A; and the temperature measurement of oneself where the measurer A's forehead is pointed with the fore end portion 2a of the casing 2 by oneself, a sense of unpleasantness or a sense of discomfort is reduced as compared with the case where the pointed end is pointed at the face.

In both cases of another person's temperature measurement and the temperature measurement of oneself, the measurer can hold the non-contact thermometer 1 such that the base end portion 2b of the casing 2 comes into contact with the palm. Since the base end portion 2b of the casing 2 has a spherical shape, it is possible to suppress occurrence of a sense of discomfort at a portion with which the base end portion 2b is in contact.

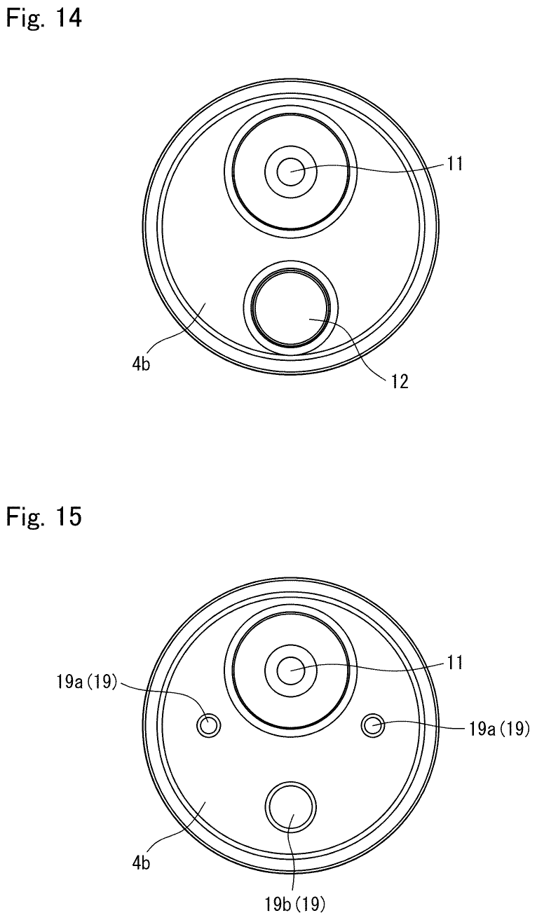

FIGS. 14 and 15 show modifications of the present invention. Configurations and the like not particularly mentioned in these modifications are the same as those of the embodiment.

The non-contact thermometer 1 according to the first modification illustrated in FIG. 14 includes a built-in distance sensor 12 in which a light emitting element and a light receiving element are integrated. The laser light emitted from the light emitting element and reflected by the human body (forehead) is received by the light receiving element, whereby the distance to the measurement site (forehead) is measured. In both of the temperature measurement of another person and the temperature measurement of oneself, when the non-contact thermometer 1 that has been brought to be in the power-on state by the operation of the power button 15 is brought close to the measurement site (forehead) and the distance sensor 12 detects that the sensor surface 4b has come close to the measurement site to a distance suitable for temperature measurement by the infrared sensor 11, the measurer is prompted to operate the measurement button 13 by ringing or vibration of the buzzer. As a result, even in the case of an unfamiliar measurer or in the case where there is a physical difference between the measurer and the subject, the non-contact thermometer 1 can be easily adjusted to an appropriate positional relationship, angle, and distance with respect to the forehead which is the measurement site. That is, it is possible to assist the measurer to adjust the non-contact thermometer 1 to an appropriate positional relationship, angle, and distance with respect to the forehead. When the distance sensor 12 detects that the sensor surface 4b approaches the measurement site to a distance suitable for temperature detection by the infrared sensor 11, temperature measurement by the infrared sensor 11 may be automatically executed.

The non-contact thermometer 1 according to the second modification illustrated in FIG. 15 includes a built-in distance sensor 19 including a pair of light emitting elements 19a and 19a and a single light receiving element 19b. The function of the distance sensor 19 is similar to that of the first modification (FIG. 14). By providing the pair of light emitting elements 19a and 19a, the measurer can also be assisted with respect to adjustment of the left and right postures of the non-contact thermometer 1. For example, it is possible to notify the measurer that the left and right postures of the non-contact thermometer 1 have become appropriate by ringing or vibration of a buzzer. Note that when the distance sensor 19 detects that the sensor surface 4 approaches the measurement site to a distance suitable for temperature measurement by the infrared sensor 11 and the left and right postures of the non-contact thermometer 1 become appropriate, temperature measurement by the infrared sensor 11 may be automatically executed.

What is claimed is:

1. A hand-held type non-contact thermometer for which a measurement site is a forehead, the non-contact thermometer comprising:
a casing having a rod shape extending along an axis and including a fore end portion with a built-in infrared sensor and a base end portion on an opposite side of the fore end portion, the axis being a line connecting centroids of a plurality of cross sections orthogonal to a longitudinal direction of the casing and being a straight line; and
a measurement button that is provided in the casing and operates a measurement function of the non-contact thermometer,
wherein the fore end portion of the casing includes a foremost end portion and a flat sensor surface extending from the foremost end portion toward the base end portion so as to be inclined with respect to the axis,
the infrared sensor is disposed in the casing so as to face the sensor surface, and
the measurement button is provided on the same side of the casing as the sensor surface in a side view.

2. The non-contact thermometer according to claim 1, wherein an inclination angle of the sensor surface with respect to the axis is greater than 90 degrees and less than 180 degrees.

3. The non-contact thermometer according to claim 1, wherein a recess is provided in the casing, and the measurement button is disposed in the recess.

4. The non-contact thermometer according to claim 3, wherein the measurement button has a concave shape.

5. The non-contact thermometer according to claim 1, wherein a distance between the foremost end portion and a center of the measurement button in a direction of the axis is 100 mm or less.

6. The non-contact thermometer according to claim 1, wherein the casing includes a flat portion on an opposite side to the sensor surface in a side view.

7. The non-contact thermometer according to claim 6, wherein a display unit is provided on the flat portion.

8. The non-contact thermometer according to claim 6, wherein an outline viewed from a direction of the axis of the casing is in a convex curved surface shape except for the flat portion.
